(19) United States
(12) Patent Application Publication
(10) Pub. No.: US 2019/0147653 A1
(43) Pub. Date: May 16, 2019

(54) TECHNIQUES FOR FACILITATING INTERACTIONS BETWEEN AUGMENTED REALITY FEATURES AND REAL-WORLD OBJECTS

(71) Applicant: Sounds Food, Inc., San Francisco, CA (US)

(72) Inventors: Mark Lindsay HENDERSON, New York, NY (US); Andries Albertus ODENDAAL, Cape Town (ZA)

(21) Appl. No.: 16/040,300

(22) Filed: Jul. 19, 2018

Related U.S. Application Data
(60) Provisional application No. 62/534,583, filed on Jul. 19, 2017.
(60) Provisional application No. 62/557,660, filed on Sep. 12, 2017.

(51) Int. Cl. G06T 19/00; G06T 13/20; G06K 9/00; G06K 7/14; G06F 3/01

(52) U.S. Cl. CPC G06T 19/006; G06T 13/20; G06F 3/016; G06K 7/1413; G06K 9/00201

(57) ABSTRACT

Introduced here are computer programs and computer-implemented techniques for facilitating the placement of augmented reality features in close proximity to a variety of real-world objects, such as tableware objects, drinkware objects, etc. By placing a reference object in a real-world environment, physical objects can be made more recognizable/useful within in the context of augmented reality. For example, a pattern may be printed along the surface of a real-world object to facilitate in the cropping, positioning, and/or animating of an augmented reality feature. Additionally or alternatively, a removable item may be placed on the surface of a real-world object to define a reference orientation.

### CROSS-REFERENCE TO RELATED APPLICATIONS

This application claims priority to U.S. Provisional Application No. 62/534,583, titled “Techniques for Identifying Tableware Characteristics Affecting Augmented Reality Features” and filed on Jul. 19, 2017, and U.S. Provisional Application No. 62/557,660, titled “Techniques for Facilitating Interactions Between Augmented Reality Features and Real-World Objects” and filed on Sep. 12, 2017, each of which is incorporated by reference herein in its entirety.

### RELATED FIELD

Various embodiments pertain to computer programs and associated computer-implemented techniques for facilitating authentic interactions between augmented reality features and real-world objects.

### BACKGROUND

Augmented reality is an interactive experience involving a real-world environment whereby the objects in the real world are “augmented” by computer-generated perceptual information. In some instances, the perceptual information bridges multiple sensory modalities, including visual, auditory, haptic, somatosensory, olfactory, or any combination thereof. The perceptual information, which may be constructive (i.e., additive to the real-world environment) or destructive (i.e., masking of the real-world environment), can be seamless interwoven with the physical world such that it is perceived as an immersive aspect of the real-world environment.

Augmented reality is intended to enhance an individual's perception of reality, whereas, in contrast, virtual reality replaces the real-world environment with a simulated on. Augmentation techniques may be performed in real time or in semantic context with environmental elements, such as overlaying supplemental information such as scores over a live video feed of a sporting event.

With the help of augmented reality technology, information about the real-world environment surrounding an individual can become interactive and digitally manipulable. For example, information about the physical world or its objects may be overlaid on a real-world environment. The information may be virtual or real. That is, the information may be associated with actual sensed/measured information (e.g., as generated by a heat sensor, light sensor, or movement sensor) or entirely fabricated (e.g., characters and items).

A key measure of augmented reality technologies is how realistically they integrate augmented reality features into real-world environments. Generally, computer software must derive real-world coordinates from image(s) captured by an image sensor in a process called image registration. Image registration may require the use of different techniques for computer vision related to video tracking. However, proper placement of augmented reality features remains difficult to achieve, particularly when the real-world environment includes objects that have few distinguishable features.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1A illustrates how a computer program (e.g., a mobile application) may be configured to initiate a live view of a branded foodstuff.

FIG. 1B illustrates how the computer program may be used to scan a branded code affixed to the packaging of a branded foodstuff.

FIG. 2 depicts a live view of a foodstuff that is captured by a mobile phone.

FIG. 3 illustrates how a portion of an augmented reality feature may be visible when an individual (e.g., a child) views a foodstuff through a mobile phone.

FIG. 4 depicts a tableware object (here, a bowl) that includes a pattern that facilitates in the placement of an augmented reality feature.

FIG. 5A depicts how a single pattern may be used to intelligently arrange multiple augmented reality features.

FIG. 5B depicts how the pattern may be used to intelligently animate an augmented reality feature (e.g., with respect to a tableware object or another augmented reality feature).

FIG. 5C depicts how the pattern can facilitate more accurate/precise zooming on augmented reality features.

FIG. 6 depicts a tableware object (here, a bowl) that includes a removable rim that facilitates the placement of augmented reality features in close proximity to the tableware object.

FIG. 7A illustrates a computer-generated vehicle approaching a real-world ramp.

FIG. 7B illustrates the computer-generated vehicle after it has interacted with the real-world ramp.

FIG. 8A depicts a ladder that can be leaned up against a tableware object and, in some embodiments, is folded over the lip of the tableware object.

FIG. 8B depicts a soccer goal with which a computer-generated soccer ball can interact.

FIG. 8C depicts a finishing post where a checkered flag may be dropped/raised after a computer-generated vehicle has driven past.

FIG. 9 depicts an example of a network environment that includes a mobile phone having a mobile application configured to present augmented reality features that are embedded within or disposed beneath foodstuff(s) and a network-accessible server system responsible for supporting the mobile application.

FIG. 10 depicts a flow diagram of a process for generating more authentic augmented reality features.

FIG. 11 depicts a flow diagram of a process for animating augmented reality features in a more authentic manner.

FIG. 12 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Augmented reality has many applications. For example, early applications of augmented reality include military (e.g., video map overlays of satellite tracks), education (e.g., computer-generated simulations of historical events), and medicine (e.g., superposition of veins onto the skin).

Augmented reality could also be used to incentivize the consumption of foodstuffs. For example, a parent may initiate a mobile application residing on a mobile phone, and then scan a plate including one or more foodstuffs by initiating a live view that is captured by an image sensor (e.g., an RGB camera). The term “foodstuffs” is used to generally refer to any type of food or beverage. While the mobile application may be configured to automatically identify recognizable features indicative of a certain foodstuff (e.g., shapes and colors), the parent will typically need to indicative which foodstuff(s) on the plate should be associated with an augmented reality feature.

The parent may select a given foodstuff (e.g., spinach) that a child is least likely to consume from multiple foodstuffs arranged on a tableware object, such as a plate or a bowl. When the child views the given foodstuff using the mobile phone, a portion of an augmented reality feature could be shown. As the child consumes the given foodstuff, additional portion(s) of the augmented reality feature are exposed and the augmented reality feature becomes increasingly visible. Such a technique incentivizes the child to continue eating the given foodstuff so that the augmented reality feature can be fully seen.

Techniques for generating augmented reality features are further described in U.S. application Ser. No. 15/596,643, which is incorporated herein by reference in its entirety.

Augmented reality software development kits (SDKs) (e.g., Vuforia®) typically determine where to place augmented reality features based on detected objects, features, patterns, etc. However, positioning augmented reality features relative to other objects, both virtual and physical, remains a challenge. For example, augmented reality features are often difficult to place inside or near round real-world objects (e.g., bowls) because these objects typically have no identifying features, and thus are difficult to correctly orient.

Introduced here, therefore, are computer programs and computer-implemented techniques for facilitating the placement of augmented reality features in close proximity to a variety of real-world objects, such as tableware objects, drinkware objects, etc. By placing a reference object in a real-world environment, physical objects can be made more recognizable/useful within in the context of augmented reality. Examples of reference objects include physical objects having a patterned surface, physical objects having a known characteristic (e.g., a removable item or a toy), etc.

For example, a pattern may be placed on the surface of a tableware objects. In some embodiments the pattern is printed on the surface of the tableware object during the manufacturing process, while in other embodiments the pattern is affixed to the surface of the tableware object following the manufacturing process (e.g., via a lamination process). The pattern can help address the difficulties caused by tableware object (e.g., a cylindrical glass or a parabolic bowl) having no real “sides.” Conventional SDKs are often unable to tableware objects often make it more difficult to properly crop, position, and/or animate augmented reality features located in close proximity to tableware objects. The patterns described herein, however, can make it easier to detect the structural characteristics of a real-world object, such as a tableware object. The patterns may also make it easier to detect how much foodstuff remains in a tableware object, which can affect how an augmented reality feature should be cropped, animated, etc.

Additionally or alternatively, a removable item may be placed on the surface of a real-world object to define a reference orientation. Said another way, a removable item may be detachably connected to another physical object to define the reference orientation. For example, a removable tab may be affixed to a tableware object near the edge, a drinkware object near a handle, etc. As another example, a removable rim may be placed on the surface of a tableware object, drinkware object, etc. Much like the pattern described above, the removable rim may help address the difficulties associated with round real-world objects. For instance, the removable rim may define an upper periphery that makes it easier to estimate height/volume of the corresponding real-world object, depth of foodstuff remaining in the corresponding real-world object, etc.

In some embodiments the removable rim includes a pattern (e.g., a non-repeating pattern), while in other embodiments the removable rim includes sufficient structural/aesthetic variations to be distinguishable from the real-world object to which it is affixed. The removable rim may be cut to fit various circumferences, shapes, etc. In such embodiments, the material may be delivered in the form of a roll, and then unrolled and cut/torn to size. In some embodiments, the removable rim is comprised of rubber, silicone, or some other material that can be readily stretched to fit a real-world object. In other embodiments, the removable rim is comprised of an adhesive tape that can be easily affixed to the real-world object.

The technology described herein may also allow augmented reality features to prompt physical responses from real-world objects. In such embodiments, augmented reality features and real-world objects may interact with one another as if both items are physical in nature.

Although certain embodiments may be described in the context of a removable rim designed for a tableware object, those skilled in the art will recognize that these examples have been selected for the purpose of illustration only. The technology could also be affixed to other parts of a tableware object, drinkware object, etc. For example, some embodiments of the removable rim may be designed to be secured to the base of a tableware object, drinkware object, etc. Similarly, removable rims could be designed for other types of real-world objects.

Embodiments may be described with reference to particular computer programs, electronic devices, networks, etc. However, those skilled in the art will recognize that these features are equally applicable to other computer program types, electronic devices, network types, etc. For example, although the term “mobile application” may be used to describe a computer program, the relevant feature may be embodied in another type of computer program.

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform a process for examining an image of a real-world environment, identifying a patterned/unpatterned object intended to define a spatial orientation, generate an augmented reality feature, position the augmented reality feature in the real-world environment based on a position of the patterned/unpatterned object, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

### System Topology Overview

Various technologies for facilitating the placement of augmented reality objects in close proximity to real-world objects are described herein. Examples of real-world objects include tableware objects (also referred to as “eating vessels”), drinkware objects (also referred to as “drinking vessels”), silverware objects, toys, etc. Examples of tableware objects include plates, bowls, etc. Examples of drinkware objects include glasses, mugs, etc. Examples of silverware objects include forks, spoons, knives, etc. Examples of toys include ladders, ramps, goals, cards, etc. Although certain embodiments may be described in terms of “tableware objects,” those skilled in the art will recognize that similar concepts are equally applicable to these other types of real-world objects.

Examples of augmented reality features include digital representations of creatures (e.g., humanoid characters, such as athletes and actors, and non-humanoid characters, such as dragons and dinosaurs) and items (e.g., treasure chests, trading cards, jewels, coins, athletic equipment such as goals and balls, and vehicles such as cars and motorcycles). The digital representations can be created using real textures (e.g., two-dimensional (2D) or three-dimensional (3D) footage/photographs) that are mapped onto computer-generated structures. For example, real images or video footage sequences of a shark could be mapped onto a 3D animated sequence. In other embodiments, the digital representations are illustrations not based on real images/video.

Generally, an individual (e.g., a parent) initiates a computer program on an electronic device that scans a tableware object within which an augmented reality feature is to be placed. For example, the computer program may initiate a live view captured by an image sensor (e.g., an RGB camera) or capture a static image using the image sensor. The individual may initiate the computer program by selecting a corresponding icon presented by the electronic device, and then direct a focal point of the image sensor toward the foodstuff.

A pattern may be affixed to the surface of the tableware object to facilitate the placement of the augmented reality object in close proximity to the tableware object. For example, the computer program may determine how an augmented reality object should be cropped and/or animated based on which portion(s) of the pattern are detectable at a given point in time. A pattern could also be affixed to a surface near the tableware object. For example, a normal tableware object (i.e., one without a visible pattern) may be placed on a patterned placemat or near a patterned utensil. In some embodiments, these patterns are used together to better understand spatial relationships. Thus, a patterned tableware object may be placed on a patterned placemat. Different types of patterns may enable to application to better understand spatial position of the patterned tableware object, as well as other real-world objects (e.g., drinkware and silverware).

Additionally or alternatively, a removable item may be affixed to a tableware object (e.g., along the rim or base) to facilitate the placement of the augmented reality object in close proximity to the tableware object. In such embodiments, the computer program may determine how an augmented reality feature should be cropped and/or animated based on the position/orientation of the removable rim. For example, a ramp, ladder, or some other physical object could be used to indicate which tableware object an augmented reality feature should interact with. Moreover, the known properties of the physical object could assist in determining features such as height, width, orientation, etc., of the tableware object.

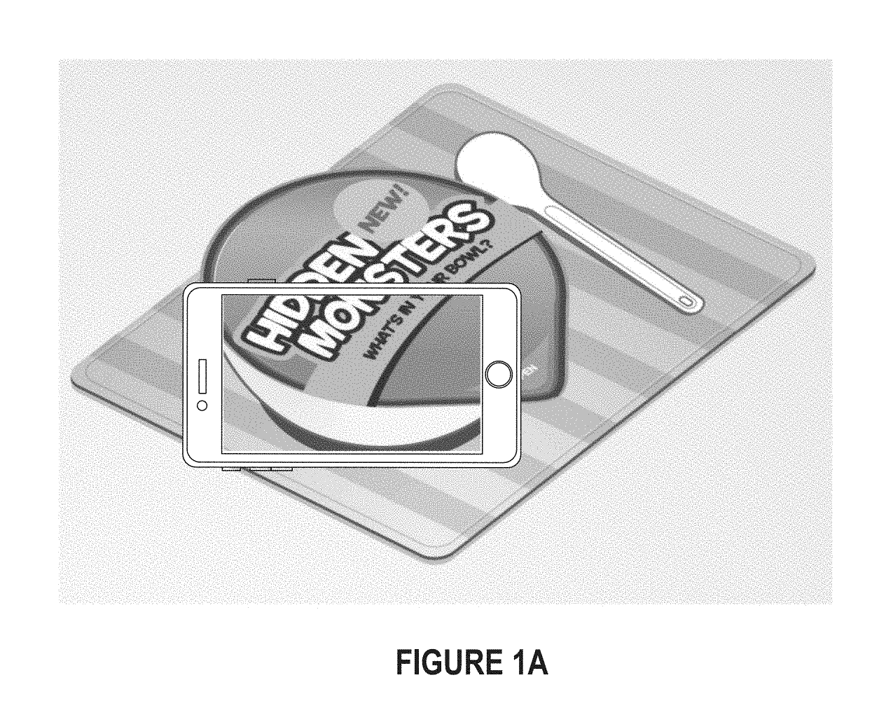

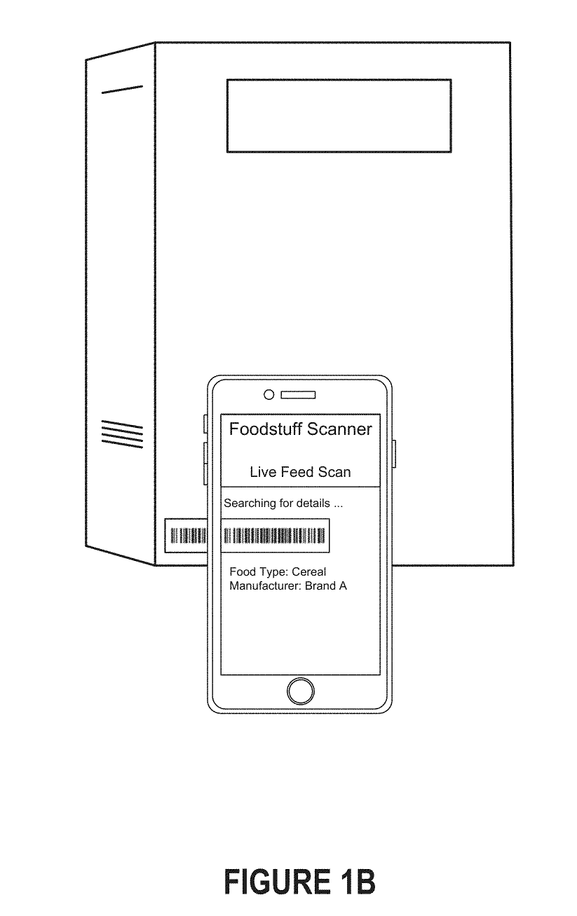

FIG. 1A illustrates how a computer program (e.g., a mobile application) may be configured to initiate a live view of a branded foodstuff. A “branded foodstuff” is a foodstuff that is associated with a particular brand. In some embodiments, the computer program parses the live video feed captured by an image sensor for real-time recognition purposes in order to identify alphanumeric character(s), symbol(s), and/or design(s) that are indicative of a particular brand. Together, these elements define a particular syntax or pattern that corresponds to the particular brand. Here, for example, the computer program may identify the type of foodstuff based on the presence of the terms “Hidden Monsters,” the color of the lid, the shape of the tableware object, etc.

Specific foodstuffs may come with branded codes that can be scanned by an individual using an electronic device (e.g., a mobile phone). FIG. 1B illustrates how the computer program may be used to scan a branded code affixed to the packaging of a branded foodstuff. The branded code could also be affixed to a loose item (e.g., a card or a toy) that is secured within the packaging of the branded foodstuff. For example, a branded code could be affixed to a paper card that is placed in a cereal box. Additionally or alternatively, an individual (e.g., a parent or a child) could scan a purchase receipt as alternate proof of foodstuff purchase.

A branded code can be composed of some combination of machine-readable elements, human-readable elements, and/or structural elements. Machine-readable elements (e.g., bar codes and Quick Response (QR) codes) are printed or electronically-displayed codes that are designed to be read and interpreted by an electronic device. Machine-readable elements can include extractable information, such as foodstuff type, foodstuff manufacturer, etc. Human-readable elements (e.g., text and images) may be co-located with the machine-readable elements and identified using various optical character recognition (OCR) techniques. Structural elements (e.g., emblems, horizontal lines, and solid bars) may also be used to identify a branded foodstuff from a branded code.

In some embodiments, a branded foodstuff uniquely corresponds to the type of pattern affixed to the corresponding tableware object. For example, upon identifying the terms “Hidden Monsters,” the computer program may know what type of pattern should be affixed to the tableware object. Linkages between branded foodstuff(s) and pattern type(s) could be hosted locally by the computer program (e.g., within a memory of a mobile phone) and/or remotely by a network-accessible server responsible for supporting the computer program.

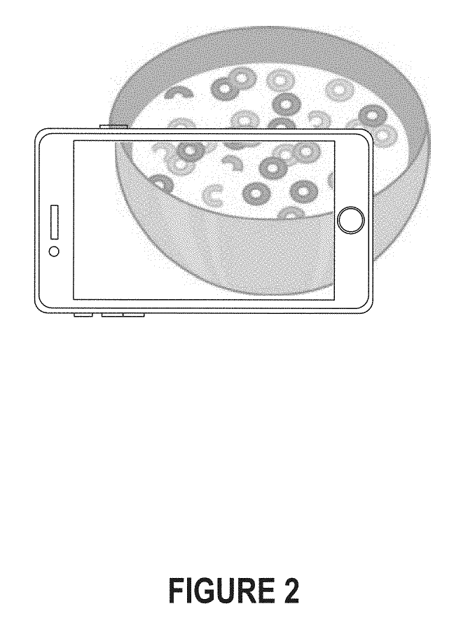

FIG. 2 depicts a live view of a foodstuff that is captured by a mobile phone. In some embodiments, a mobile application residing on the mobile phone is configured to automatically identify recognizable foodstuff features. For example, the mobile application may apply image processing algorithms to identify certain shapes and/or colors that are indicative of certain foodstuffs (e.g., green spherical structures for peas, orange tubular structures for carrots, white liquid for milk). More specifically, the mobile application may perform image segmentation (e.g., thresholding methods such as Otsu's method, or color-based segmentation such as K-means clustering) on individual frames of a live video feed to isolate regions and objects of interest.

In other embodiments, the mobile application identifies foodstuff(s) upon receiving user input from an individual who indicates which foodstuff(s) should be associated with an augmented reality feature. For example, if a parent wanted to associate peas with an augmented reality feature, then the parent may be able to simply select a mound of peas presented on the screen of the mobile phone (e.g., by tapping the display of the mobile phone). Thus, the parent could select a foodstuff that a child is least likely to consume from one or more foodstuffs on a plate. As another example, if a parent wanted to associate carrots with an augmented reality feature, then the parent may be able to simply specify (e.g., via an interface accessible through the mobile application) a selection of carrots. When the mobile application discovers carrots in a future image, an augmented reality feature may be automatically positioned in/around the carrots. Thus, the parent may not need to select a particular foodstuff in an image. Instead, the parent could specify what foodstuff(s) should be identified in future images.

The mobile application need not necessarily know the type of the selected foodstuff. That is, the mobile application need not necessarily know whether a selected foodstuff is peas, carrots, spinach, etc. Instead, the mobile application may only care about the geometrical characteristics of the selected foodstuff. Knowledge of the geometrical characteristics allows the application to realistically embed augmented reality feature(s) within the selected foodstuff.

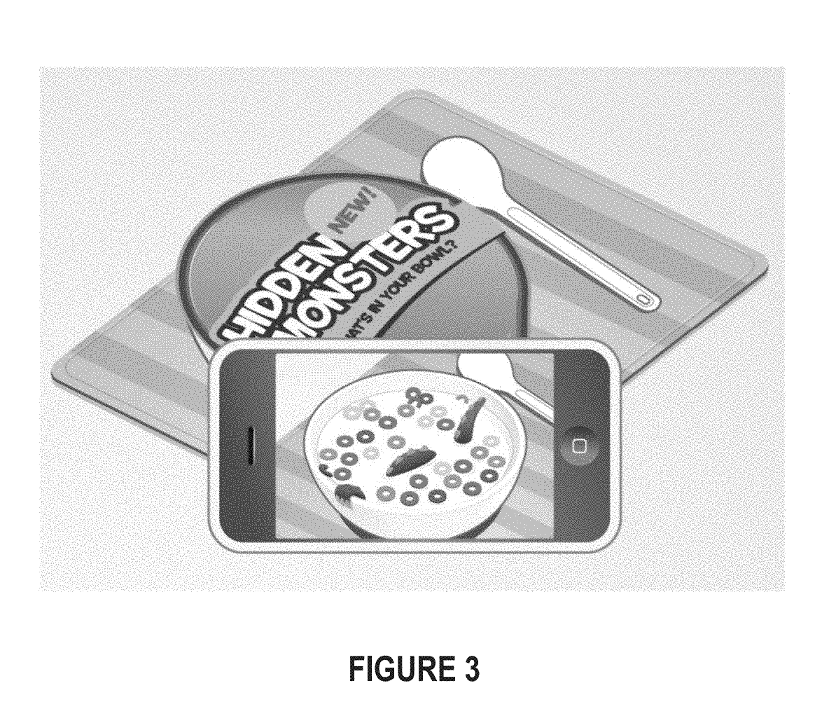

FIG. 3 illustrates how a portion of an augmented reality feature may be visible when an individual (e.g., a child) views a foodstuff through a mobile phone. The portion of the augmented reality feature that is shown can also be referred to as a “hint” or “teaser” of the reward that awaits the individual once she finishes consuming some or all of the foodstuff. While the foodstuff shown here is associated with a single augmented reality feature, a foodstuff could also be associated with multiple augmented reality features. For example, multiple digitally animated coins/jewels may be distributed throughout a bowl of cereal or a mound of peas.

The visible portion(s) of the augmented reality feature indicate that something is hidden within or beneath the foodstuff. Here, for example, portions of a digitally animated dragon are visible when the foodstuff is viewed through the mobile phone. As noted above, augmented reality features can take many different forms, including creatures (e.g., humanoid characters and non-humanoid characters, such as dragons and dinosaurs) and items (e.g., treasure chests, trading cards, jewels, and coins).

Animations may also be used to indicate the realism of the augmented reality features. In some embodiments, different appendages (e.g., arms, legs, tails, or head) may emerge from a foodstuff over time. For example, the digitally animated dragon of FIG. 3 may swim through the bowl of cereal over time. Additionally or alternatively, the foodstuff itself may appear as though it is animated. For example, the surface of the bowl of milk may include ripples caused by certain swimming actions or bubbles caused by breathing.

As the individual consumes the foodstuff, augmented reality feature(s) hidden within or beneath the foodstuff become increasingly visible. That is, the mobile application may present a “payoff” upon determining that the foodstuff has been consumed by the child. Such a technique incentivizes the individual to continue eating certain foodstuff(s) so that the corresponding augmented reality feature(s) can be fully seen. In some embodiments, the “payoff” simply includes presenting an entire augmented reality feature for viewing by the individual. In other embodiments, the “payoff” is a digital collectible corresponding to the augmented reality feature. For example, consuming the foodstuff may entitle the individual to a benefit related to the augmented reality feature, such as additional experience (e.g., for leveling purposes), additional items (e.g., clothing), etc. Thus, an augmented reality feature may change its appearance/characteristics responsive to a determination that the individual has eating the corresponding foodstuff(s) multiple times.

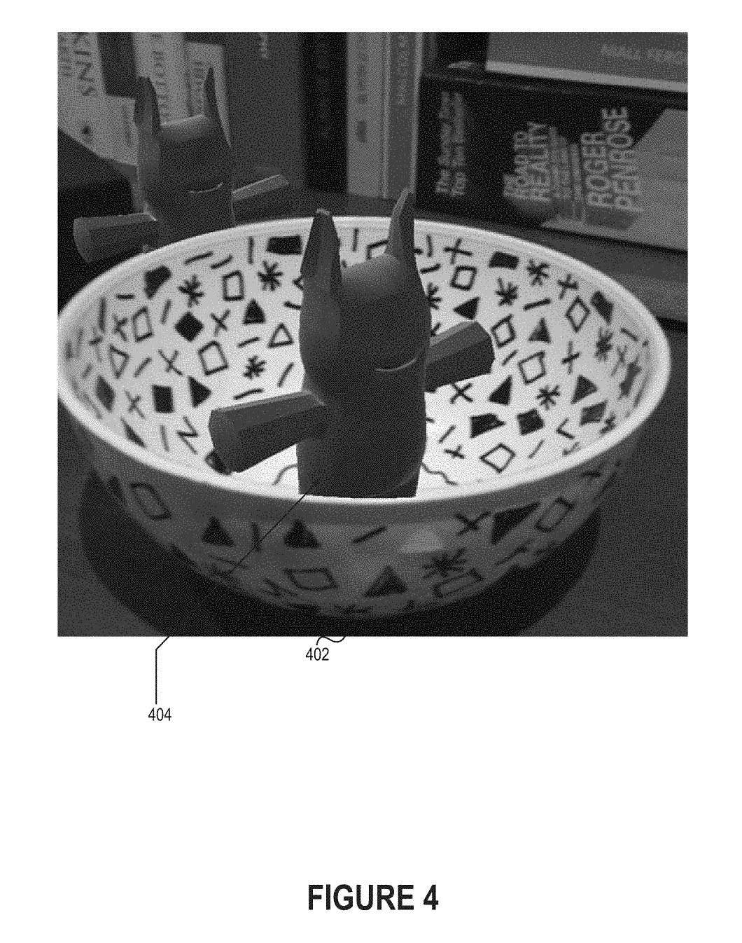

FIG. 4 depicts a tableware object 402 (here, a bowl) that includes a pattern that facilitates in the placement of an augmented reality feature 404. As noted above, placing augmented reality features in close proximity to round real-world objects (e.g., bowls) has historically been difficult because these objects often have no identifying features, and thus are difficult to correctly orient. By detecting/monitoring the pattern, a computer program can more easily produce an augmented reality feature 404 that acts in a realistic manner with respect to the tableware object 402. The pattern may also facilitate animation of the augmented reality feature(s). For example, a computer program may perform various pattern recognition techniques to detect different structural characteristics (e.g., vertical height, sidewall pitch/slope, whether a lip is present) that are likely to affect the realism of actions performed by augmented reality features.

The pattern is typically affixed to (e.g., printed on) the tableware object 402 during the manufacturing process. However, in some embodiments the pattern is affixed to the tableware object 402 during a separate post-manufacturing process.

The pattern may be visible on the inner surface, the outer surface, or both. Consequently, the pattern can help address the difficulties caused by round tableware objects (e.g., bowls) that have no real “sides.” In fact, round tableware objects often make it more difficult to properly crop augmented reality objects due to their pitched sides, featureless sides/lip, etc.

A pattern can include geometric shapes, alphanumeric characters, symbols, and/or images that allow the orientation of a tableware object to be more easily determined. Here, for example, the pattern includes alphanumeric characters and geometric shapes having different fills (e.g., solid, empty, striped). However, embodiments could include any combination of geometric shapes (e.g., squares, triangles, circles), alphanumeric characters (e.g., brand names or foodstuff names), symbols (e.g., @, &, *), and/or images (e.g., brand logos or pictures corresponding to the augmented reality object). Thus, the pattern may be designed to be substantially indistinguishable from other packaging accompanying the tableware object. Moreover, these different pattern elements could be in the same or different colors. The benefits are particularly noticeable for round real-world objects, which can be viewed/treated as many-sided objects based on the pattern. That is, the pattern can be used to reliably define an orientation.

As shown here, the pattern may be readily visible to an individual (e.g., a child) who is to consume foodstuff(s) from the tableware object. However, the pattern could also be substantially transparent or indistinguishable to the individual. For example, the pattern may be printed using inks (e.g., infrared (IR) inks or ultraviolet (UV) inks) that are only detectable by IR-sensitive or UV-sensitive optical sensors. As another example, the pattern may include simple geometric shapes (e.g., dots or concentric lines) that do not visually flag the presence of a pattern.

A pattern may be symmetrical or asymmetrical. Here, for example, the pattern includes a non-repeating series of geometric shapes. Because each geometric shape is associated with a unique spatial location (e.g., a specific distance from the bottom, lid, and other elements of the pattern), a computer program can readily determine how much foodstuff remains in the tableware object (which may affect how the augmented reality object is cropped and/or animated).

Additionally or alternatively, repeating series of geometric shapes may be included in the pattern. For example, a round tableware object may include multiple concentric rings of the same or different colors. Similarly, a tubular drinkware object may include multiple stacked rings of the same or different colors.

Those skilled in the art will recognize that the benefits enabled by the presence of a pattern could also be provided by a series of image processing algorithms that can accurately detect the height/width of a tableware object, the pitch/slope of each sidewall, the presence of any foodstuff(s), etc. Thus, some embodiments of the computer program can discern the same structural information from patterned real-world objects and pattern-less real-world objects.

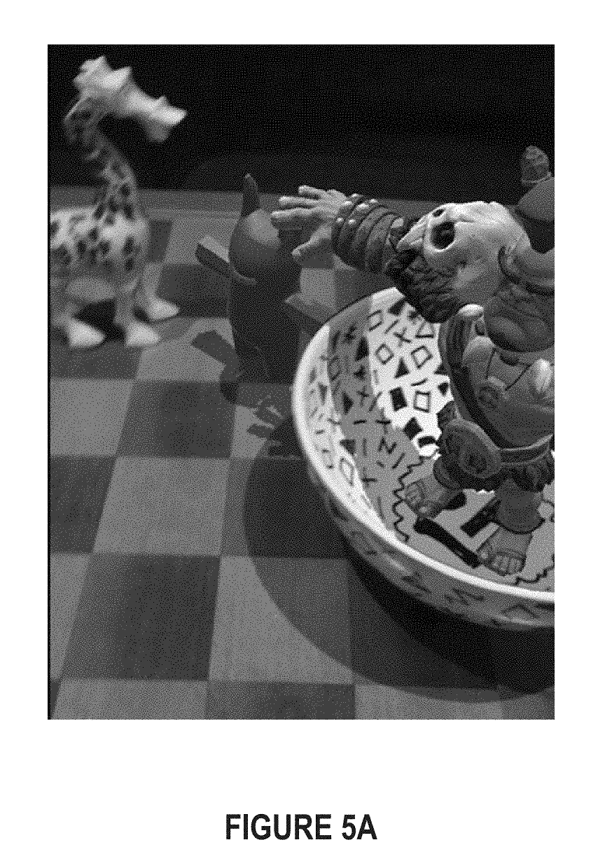

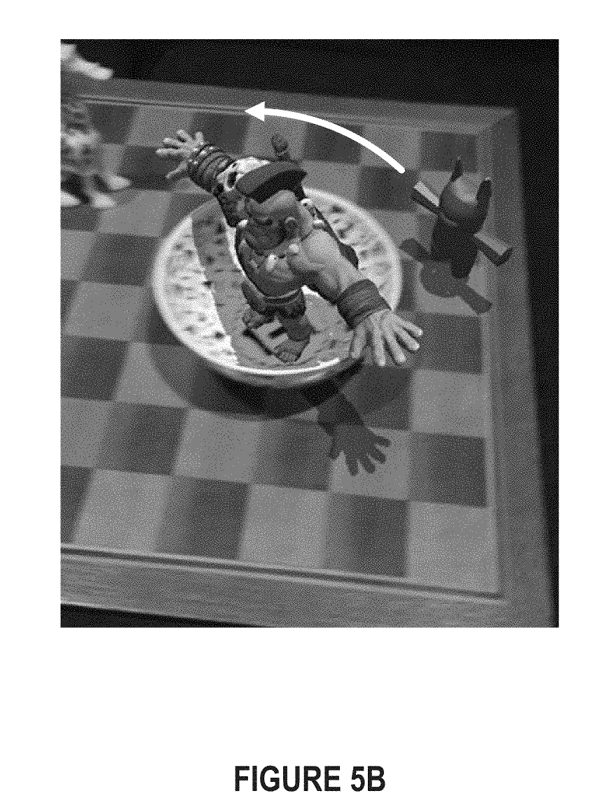

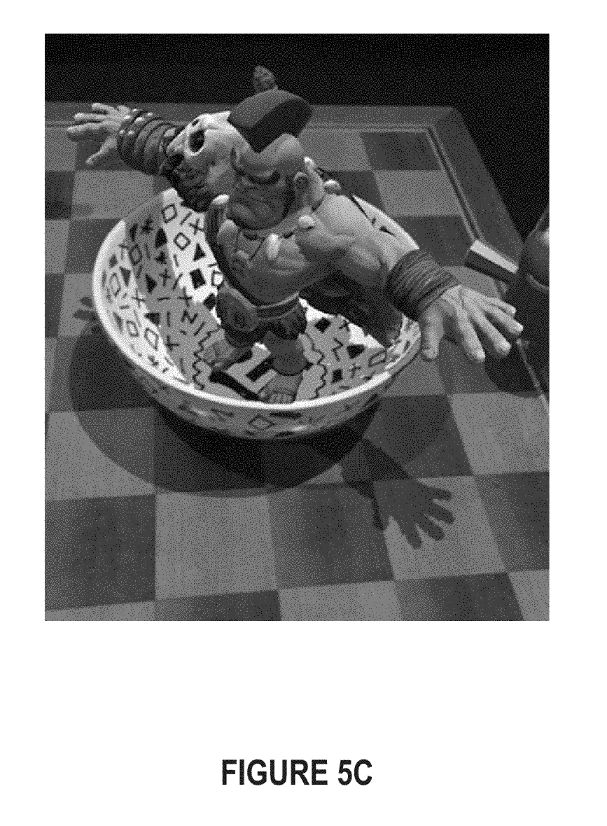

FIGS. 5A-C depict how augmented reality features may interact with one another, real-world objects, etc. More specifically, FIG. 5A depicts how a single pattern may be used to intelligently arrange multiple augmented reality features, FIG. 5B depicts how the pattern may be used to intelligently animate an augmented reality feature (e.g., with respect to a tableware object or another augmented reality feature), and FIG. 5C depicts how the pattern can facilitate more accurate/precise zooming on augmented reality features.

It may also be useful to define the orientation of a tableware object with respect to another object placed in close proximity to the tableware object. Thus, in addition to any pattern(s) affixed to the tableware object, the computer program executing on electronic device used to view the real-world environment may also detect other nearby items. Examples include actual (e.g., 3D printed) versions of the augmented reality feature, tableware, silverware, drinkware, etc. Accordingly, the computer program may be configured to scan a physical version of an item (e.g., a toy), and then generate a virtual version of the item that can be shown in the real-world environment.

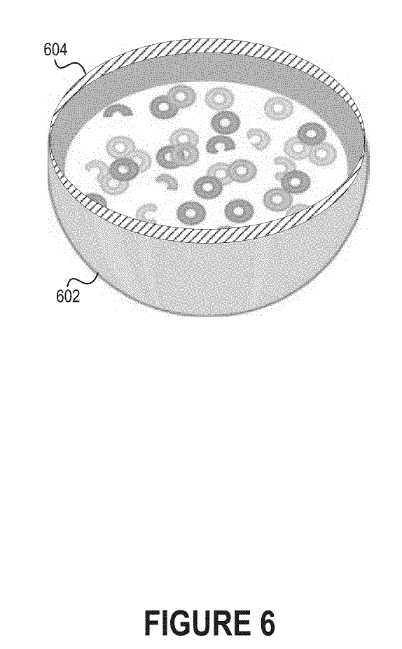

FIG. 6 depicts a tableware object 602 (here, a bowl) that includes a removable rim 604 that facilitates the placement of augmented reality features in close proximity to the tableware object 602. The removable rim 604 can make it easier to define an orientation of the tableware object 602. Moreover, the removable rim 604 can make it easier to detect how much foodstuff remains in the tableware object 602, which affects how augmented reality features should be cropped, animated, etc.

As noted above, removable items can be designed for a variety of real-world objects. Thus, a removable item may be designed to fit snugly along the rim of a tableware object as shown in FIG. 6. However, a removable item may also be designed to fit snugly along the periphery of another real-world object. In such embodiments, an individual may be able to view (e.g., via a head-mounted device) augmented reality feature(s) climbing on a couch, gaming controller, mobile phone, a human body, etc.

In some embodiments, the removable rim 604 includes a pattern (e.g., a non-repeating pattern). The pattern may facilitate the placement/animation of an augmented reality feature. For example, a computer program may perform various pattern recognition techniques to detect different structural characteristics (e.g., vertical height, rim circumference/diameter, whether a lip is present) that are likely to affect the realism of augmented reality features.

The pattern may be visible on some or all surfaces of the tableware object 602. Thus, the pattern may be visible along the inner surface, outer surface, top surface (e.g., the horizontal planar surface of a lip), etc. Consequently, the removable rim can help address the difficulties caused by round tableware objects (e.g., bowls) that have no real “sides.” Such benefits can be realized regardless of whether the removable rim is patterned.

A pattern can include geometric shapes, alphanumeric characters, and/or images that allow the orientation of a tableware object to be more easily determined. Here, for example, the pattern includes alphanumeric characters and geometric shapes having different fills (e.g., solid, empty, striped). However, embodiments could include any combination of geometric shapes (e.g., squares, triangles, circles), alphanumeric characters (e.g., brand names or foodstuff names), and/or images (e.g., brand logos or pictures corresponding to the augmented reality object). Thus, the pattern may be designed to be substantially indistinguishable from other packaging accompanying the tableware object. Moreover, these different pattern elements could be in the same or different colors. The benefits are particularly noticeable for round real-world objects, which can be viewed/treated as many-sided objects based on the pattern. That is, the pattern can be used to reliably define an orientation.

As shown in FIG. 6, the pattern may be readily visible to an individual who will consume foodstuff(s) from the tableware object 602. However, the pattern could also be substantially transparent or indistinguishable to the individual. For example, the pattern may be printed using inks (e.g., IR inks or UV inks) that are only detectable by IR-sensitive or UV-sensitive optical sensors. As another example, the pattern may include simple geometric shapes (e.g., dots or concentric lines) that do not visually flag the presence of a pattern.

A pattern may be symmetrical or asymmetrical. Here, for example, the pattern includes a repeating series of lines. Because each line can be associated with a unique spatial location (e.g., a specific distance from the edge of the removable rim and other elements of the pattern), a computer program can readily determine characteristic(s) of the tableware object 602 (which may affect how the augmented reality object is cropped and/or animated). Additionally or alternatively, repeating series of geometric shapes may be included in the pattern. For example, a removable lid for a round tableware object may include multiple concentric rings of the same or different colors. As another example, a removable sleeve for a tubular drinkware object may include a series of spots whose size and/or density varies as the distance from the top/bottom of the tubular drinkware object increases.

The removable rim may be cut to fit various circumferences, shapes, etc. In such embodiments, material may be delivered in the form of a roll, and then unrolled and cut/torn to size. In some embodiments, the removable rim is comprised of rubber, silicone, or some other material that can be readily stretched to fit a real-world object. In other embodiments, the removable rim is comprised of an adhesive tape that can be easily affixed to the real-world object.

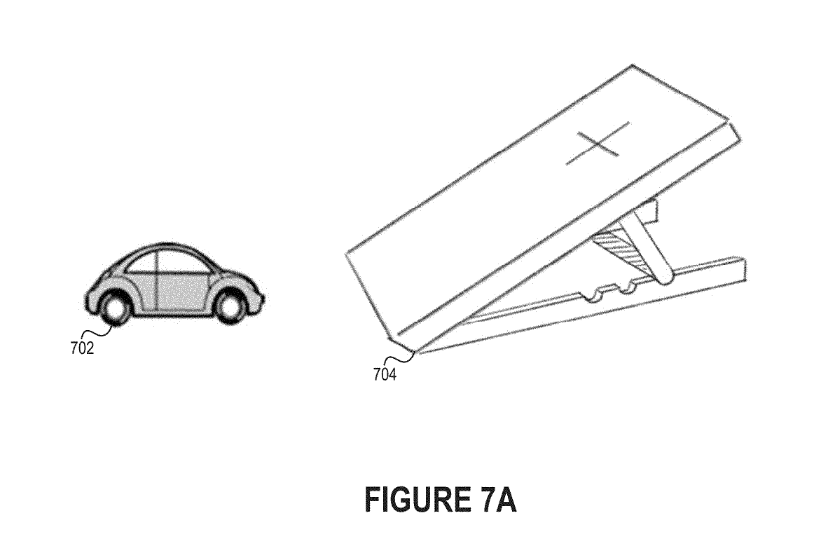

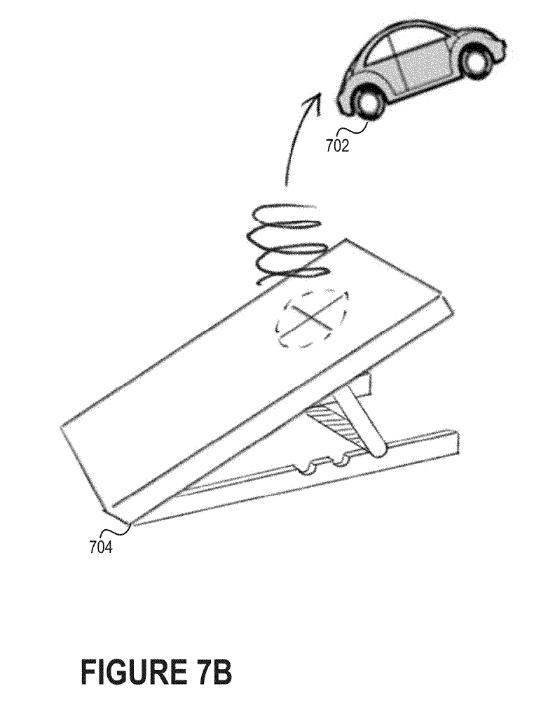

FIGS. 7A-B depict how an augmented reality feature (here, a vehicle 702) can interact with a real-world object (here, a ramp 705). More specifically, FIG. 7A illustrates a computer-generated vehicle 702 approaching a real-world ramp 704, while FIG. 7B illustrates the computer-generated vehicle 702 after it has interacted with the real-world ramp 704.

Certain embodiments have been described in the context of foodstuff(s) and/or tableware object(s). Here, for instance, the ramp 704 may be positioned such that the computer-generated vehicle 702 flies over/into a bowl after leaving the ramp 704. However, those skilled in the art will recognize that the technology can also be used in non-food-related contexts.

In some embodiments, the real-world ramp 704 is designed to be leaned against or placed near a tableware object. For example, some real-world items (e.g., ladders) may need to be connected to the tableware object (e.g., by being leaned against a sidewall or folded over an upper lip/rim), while other items can simply be placed near the tableware object. Characteristic(s) of the real-world ramp 704 may be used to help identify the size and/or orientation of a nearby tableware object (which can, in turn, improve the integration of augmented reality features). For example, the real-world ramp 704 may be associated with known height/width/length, ramp angle, vertical/horizontal markings, etc.

Similar technology may also be applied outside of food consumption. Examples include digital vehicles that, upon interacting with a real-world object, prompt:
A flag to be extended signaling the end of a lap/race;
An item to spin;
A light source to turn on/off; or
A bar/barrier to be raised or lowered.

In fact, such technology may be used to produce an obstacle course that includes at least one augmented reality feature and at least one real-world object.

Similarly, the real-world object itself could react to an action performed by the augmented reality feature. For example, the real-world ramp 704 could be raised or lowered as the computer-generated vehicle 702 traverses it, bumped/moved if the computer-generated vehicle 702 crashes into it, or popped up to provide a boost as the computer-generated vehicle 702 traverses it. These interactions between augmented reality features and real-world objects may be largely seamless in nature. Accordingly, in some embodiments, a computer program residing on an electronic device may generate a signal indicative of an animation to be performed by an augmented reality feature, and then transmit the signal to a real-world object. Receipt of the signal may prompt the real-world object to generate a sensory output (also referred to as a “sensory modality”), that is visual, auditory, haptic, somatosensory, and/or olfactory in nature.

In some embodiments, a “deckchair”-like mechanism is used to manually adjust the height of a real-world object (e.g., the real-world ramp 704 of FIGS. 7A-B). Thus, a real-world object may include a series of structural features designed to interact with each other in such a manner to enable one or more stable arrangements. A spring-loaded ratchet mechanism could be used as an alternative. For example, if a spring-loaded ratchet mechanism was made out of plastic, an individual could press down to correct the height. After the ratchet mechanism extends past a certain angle, the real-world object may revert to its original (e.g., wide) position. Real-world objects could also be moved using, for example, servomotors, haptic actuator(s), etc. For example, a real-world ramp 704 may shake in response to a computer-generated vehicle 704 crashing into it, driving over it, etc.

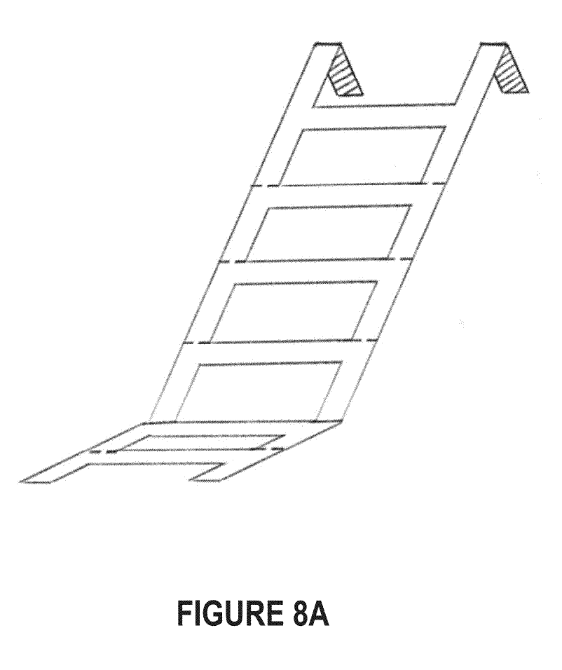

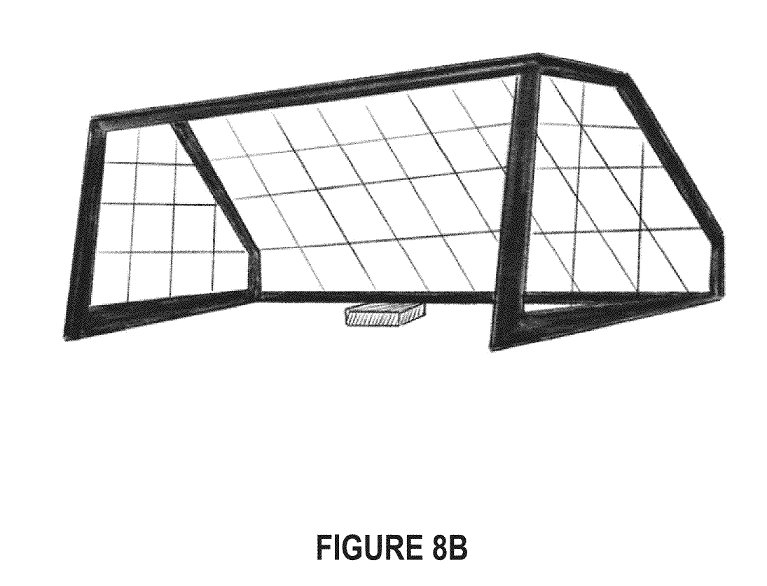

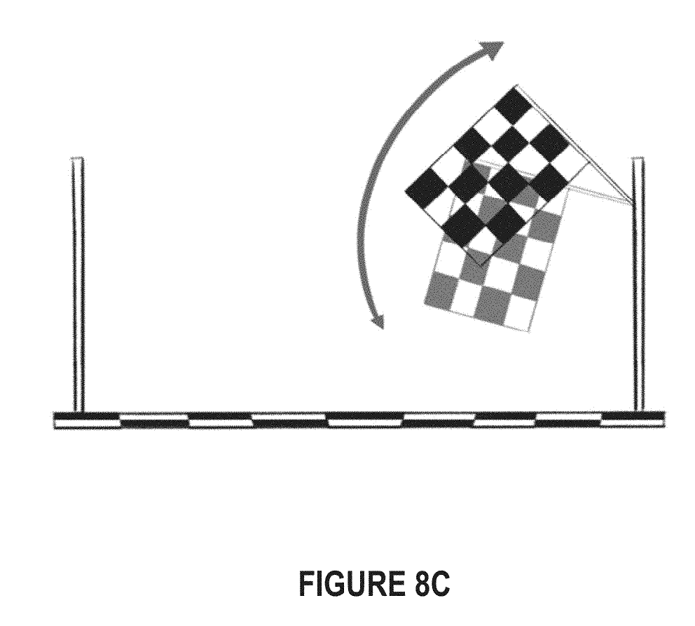

Other real-world objects may also be used to determine characteristic(s) (e.g., placement, height, or width) that affect how augmented reality features are generated, placed, animated, etc. FIGS. 8A-C depict several examples of real-world objects that may be involved in interactions with augmented reality features.

FIG. 8A depicts a ladder that can be leaned up against a tableware object and, in some embodiments, folded over the lip of the tableware object. A cardboard ladder could have a fixed fold mark along the top, and then be folded at the other end wherever it reaches the surface (e.g., of a table). Because these fold marks are typically a specified distance from one another, the fold marks could be used to determine the vertical height of the tableware object. More specifically, a computer program may estimate the height of the tableware object based on the known length of the ladder and an orientation angle as determined from an image of the ladder.

Much like the removable rim shown in FIG. 6, the ladder may be patterned. For example, the ladder may have horizontal width markings and/or vertical height markings. Similarly, each rung of the ladder may be known to be a specified distance away from the other rungs, a specified width, etc. These measures can all be used to improve the realism of interactions between augmented reality feature(s) and real-world object(s).

FIG. 8B depicts a soccer goal with which a computer-generated soccer ball can interact. For example, the soccer goal may buzz or flash after the computer-generated soccer ball enters the soccer goal. As another example, the net in the soccer goal may move based on where the soccer ball enters the soccer goal. Similar technology may be applied to hockey goals, basketball hoops, etc.

FIG. 8C depicts a finishing post where a checkered flag may be dropped/raised after a computer-generated vehicle has driven past. Similarly, fences or barriers may be used to define a course or demarcate where the computer-generated vehicle should trigger a physical response (e.g., a sound, movement, or light) when a collision occurs.

The real-world objects may be comprised of cardboard, wood, plastic, metal, etc. While nearly any suitable material(s) may be used, some real-world objects may be designed for short-term use (and thus be comprised of degradable/compostable/recyclable materials) while other real-world objects may be designed for long-term use (and thus be comprised of more durable materials).

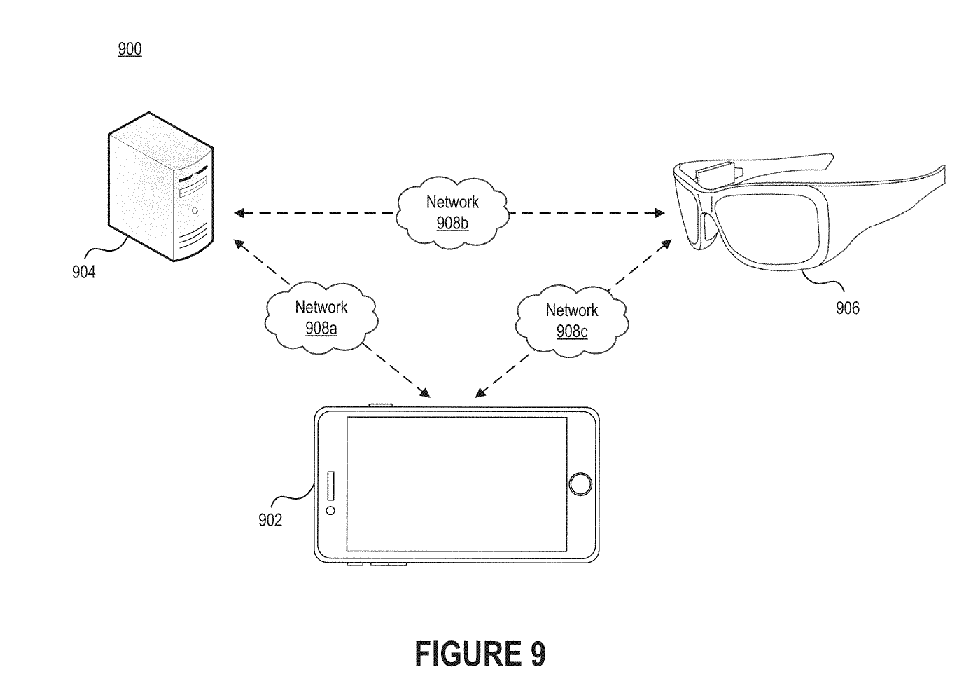

FIG. 9 depicts an example of a network environment 900 that includes a mobile phone 902 having a mobile application configured to present augmented reality features that are embedded within or disposed beneath foodstuff(s) and a network-accessible server system 904 responsible for supporting the mobile application. Generally, the network environment 900 will only include the mobile phone 902 and the network-accessible server system 904. However, in some embodiments, the network environment 900 also includes another computing device 906 (here, a head-mounted device) in addition to, or instead of, the mobile phone 902. In other embodiments, the network environment 900 only includes the mobile phone 902. In such embodiments, the mobile application residing on the mobile phone 902 may include the assets necessary to generate augmented reality features, and thus may not need to maintain a connection with the network-accessible server system 904.

While many of the embodiments described herein involve mobile phones, those skilled in the art will recognize that such embodiments have been selected for the purpose of illustration only. The technology could be used in combination with any electronic device that is able to present augmented reality content, including personal computers, tablet computers, personal digital assistants (PDAs), game consoles (e.g., Sony PlayStation® or Microsoft Xbox®), music players (e.g., Apple iPod Touch®), wearable electronic devices (e.g., watches or fitness bands), network-connected (“smart”) devices (e.g., televisions and home assistant devices), virtual/augmented reality systems (e.g., head-mounted displays such as Oculus Rift® and Microsoft Hololens®), or other electronic devices.

The mobile phone 902, the network-connected server system 904, and/or the other computing device 906 can be connected via one or more computer networks 908a-c, which may include the Internet, personal area networks (PANs), local area networks (LANs), wide-area networks (WANs), metropolitan area networks (MANs), cellular networks (e.g., LTE, 3G, 4G), etc. Additionally or alternatively, the mobile phone 902, the network-connected server system 904, and/or the other computing device 906 may communicate with one another over a short-range communication protocol, such as Bluetooth®, Near Field Communication (NFC), radio-frequency identification (RFID), etc.

Generally, a mobile application executing on the mobile phone 902 can be configured to either recognize a pattern on the surface of a tableware object (e.g., a bowl) or recognize a removable item affixed to the tableware object, automatically detect certain characteristics (e.g., height, width, or orientation) of real-world objects (e.g., tableware objects, drinkware objects, silverware objects, furniture, or toys such as those depicted in FIGS. 8A-C), etc. The network-connected server system 904 and/or the other computing device 906 can be coupled to the mobile phone 902 via a wired channel or a wireless channel. In some embodiments the network-accessible server system 904 is responsible for applying pattern recognition technique(s) to identify key features (e.g., visual markers) within the pattern, while in other embodiments the mobile phone 902 applies some or all of the pattern recognition technique(s) locally. Therefore, in some instances the mobile phone 902 may execute the techniques described herein without needing to be communicatively coupled to any network(s), other computing devices, etc.

Examples of pattern recognition techniques include image segmentation (e.g., thresholding methods such as Otsu's method, or color-based segmentation such as K-means clustering) on individual frames of a video feed to isolate pattern elements (e.g., general regions and/or specific objects) of interest.

The mobile application executing on the mobile phone 9602 and/or the network-connected server system 904 may also apply machine learning (ML) algorithms and/or artificial intelligence (AI) algorithms to improve the processes of recognizing patterns, modifying (e.g., cropping) augmented reality features, animating augmented reality features, etc. Examples include Naïve Bayes Classifier algorithms, K Means Clustering algorithms, Support Vector Machine algorithms, linear regression, logic regression, artificial neural networks, etc. These algorithms/techniques may be chosen based on application (e.g., supervised or unsupervised learning) and optimized based on how an individual (e.g., a child) reacts to outputs (e.g., augmented reality features) produced by the mobile application executing on the mobile phone 902.

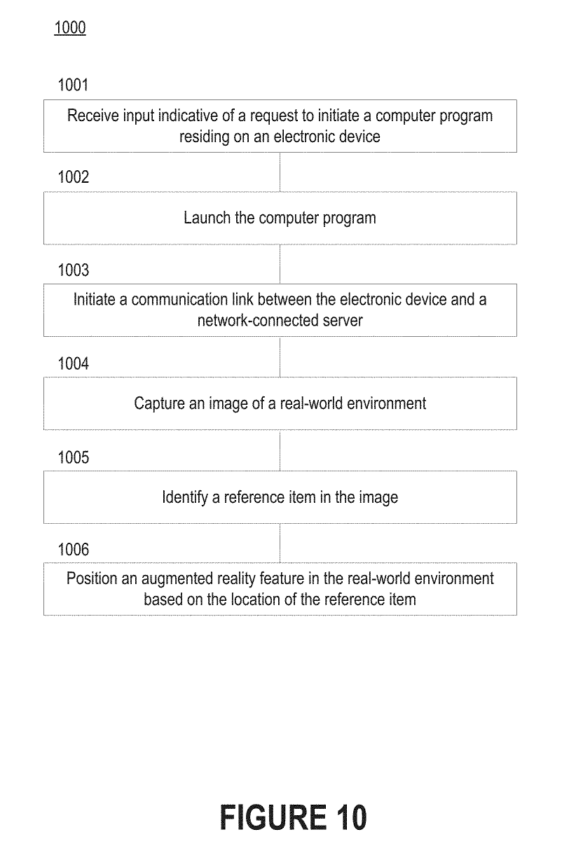

FIG. 10 depicts a flow diagram of a process 1000 for generating more authentic augmented reality features. Initially, an electronic device can receive input indicative of a request to initiate a computer program residing on an electronic device (step 1001). The electronic device may be, for example, a mobile phone. Thus, upon receiving input (e.g., provided via a touch-sensitive display), the mobile phone may initiate a mobile application. In response to receiving the input, the electronic device can launch the computer program (step 1002).

The computer program can cause a communication link to be established between the electronic device and a network-connected server (step 1003). The network-connected server may be part of a network-connected server system that supports various back-end functionalities of the computer program.

An individual can then capture an image of a real-world environment using the electronic device (step 1004). In some embodiments the image is a discrete, static image captured by an image sensor housed within the electronic device, while in other embodiments the image is one of a series of images captured by the image sensor to form a live view of the real-world environment.

The computer program can then identify a reference item in the image (step 1005). By identifying the reference item, the computer program can establish spatial relationships of objects (e.g., physical objects and/or virtual objects) in the real-world environment. Examples of reference items include objects having patterned surface(s) (e.g., the tableware object 402 of FIG. 4 and the removable rim 604 of FIG. 6), objects having non-patterned surface(s) (e.g., the ramp of FIGS. 7A-B, ladder of FIG. 8A, goal of FIG. 8B, or finishing post of FIG. 8C), etc. Generally, information will be known about the reference item that allows augmented reality features to be more seamlessly integrated into the real-world environment. For example, the reference item may be associated with known dimensions.

Accordingly, the computer program may position an augmented reality feature in the real-world environment based on the location of the reference item (step 1006). For example, after detecting a pattern on a tableware object, the computer program may know to crop certain portion(s) of an augmented reality feature to account for a sloped surface. As another example, after detecting a removable item affixed along the rim of a drinkware object, the computer program may know to animate an augmented reality feature in a certain manner (e.g., cause the augmented reality feature to climb over the rim of the drinkware object).

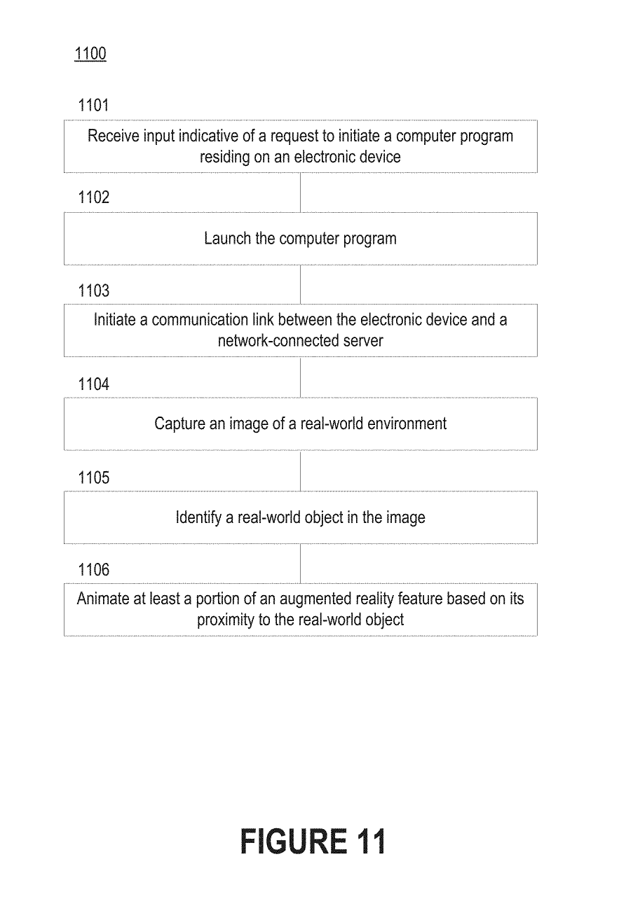

FIG. 11 depicts a flow diagram of a process 1100 for animating augmented reality features in a more authentic manner. Steps 1101-1104 of FIG. 11 may be substantially similar to steps 1001-1004 of FIG. 10. Here, however, the computer program can identify a real-world object included in the image taken by the electronic device (step 1105). As shown in FIGS. 8A-C, examples of real-world objects include ladders, goals, finishing posts, etc. Other examples of real-world objects include furniture, electronic devices, human bodies, etc.

The computer program may animate at least a portion of an augmented reality feature in the real-world environment based on its proximity to the real-world object (Step 1106). For example, upon discovering a ladder placed against a tableware object, the computer program may determine that an individual intends for an augmented reality feature (e.g., a creature) to either leave or enter the tableware object via the ladder. Accordingly, the computer program may cause the augmented reality feature to be animated in such a way that the augmented reality feature climbs up/down the ladder. As another example, upon discovering a ramp has been affixed to a track, the computer program may determine that an individual intends for an augmented reality feature (e.g., a vehicle) to traverse the track and accelerate off the ramp. Such action may cause the augmented reality feature to be animated in a manner in accordance with the individual's intent (e.g., by traversing a space adjacent to the ramp). Thus, the real-world object may serve as a reference point by which the computer program determines how to animate the augmented reality feature.

### Processing System

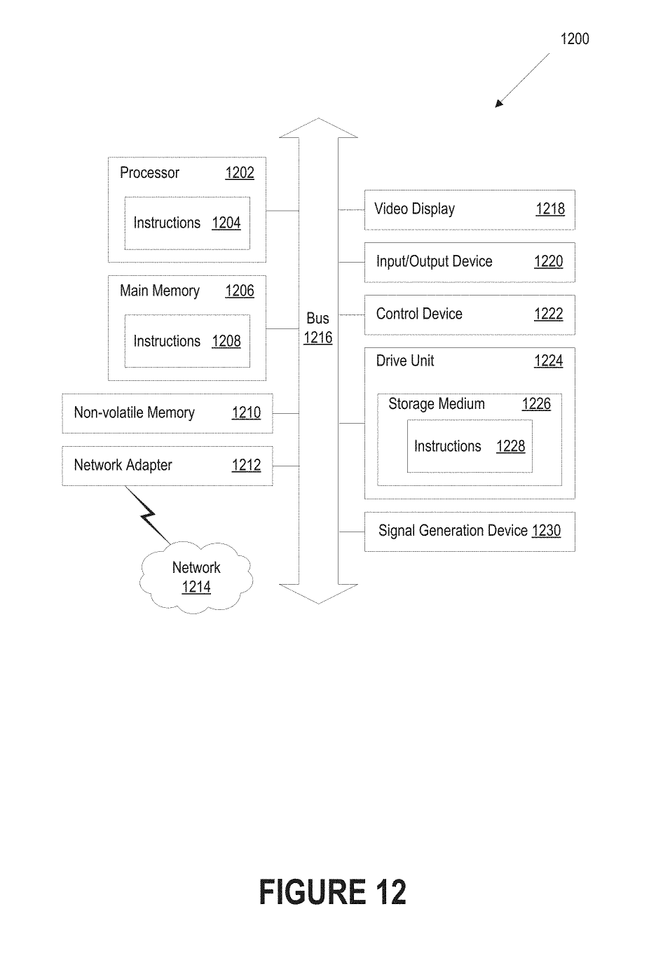

FIG. 12 is a block diagram illustrating an example of a processing system 1200 in which at least some operations described herein can be implemented. The processing system may include one or more central processing units (“processors”) 1202, main memory 1206, non-volatile memory 121210, network adapter 1212 (e.g., network interfaces), video display 1218, input/output devices 1220, control device 1222 (e.g., keyboard and pointing devices), drive unit 1224 including a storage medium 1226, and signal generation device 1230 that are communicatively connected to a bus 1216.

The bus 1216 is illustrated as an abstraction that represents one or more physical buses and/or point-to-point connections that are connected by appropriate bridges, adapters, or controllers. Therefore, the bus 1216 can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

In some embodiments the processing system 1200 operates as part of a mobile phone that executes an application configured to recognize pattern(s) on tableware objects and generate augmented reality features, while in other embodiments the processing system 1200 is connected (wired or wirelessly) to the mobile phone. In a networked deployment, the processing system 1200 may operate in the capacity of a server or a client machine in a client-server network environment, or as a peer machine in a peer-to-peer network environment. The processing system 1200 may be a server, a personal computer (PC), a tablet computer, a laptop computer, a personal digital assistant (PDA), a mobile phone, a processor, a telephone, a web appliance, a network router, a switch, a bridge, a console, a gaming device, a music player, or any machine capable of executing a set of instructions (sequential or otherwise) that specify actions to be taken by the processing system 1200.

While the main memory 1206, non-volatile memory 121210, and storage medium 1226 (also called a “machine-readable medium”) are shown to be a single medium, the term “machine-readable medium” and “storage medium” should be taken to include a single medium or multiple media (e.g., a centralized or distributed database and/or associated caches and servers) that store one or more sets of instructions 1228. The term “machine-readable medium” and “storage medium” shall also be taken to include any medium that is capable of storing, encoding, or carrying a set of instructions for execution by the processing system 1200.

In general, the routines executed to implement the embodiments of the disclosure may be implemented as part of an operating system or a specific application, component, program, object, module or sequence of instructions referred to as “computer programs.” The computer programs typically comprise one or more instructions (e.g., instructions 1204, 1208, 1228) set at various times in various memory and storage devices in a computing device, and that, when read and executed by the one or more processors 1202, cause the processing system 1200 to perform operations to execute elements involving the various aspects of the technology.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include, but are not limited to, recordable-type media such as volatile and non-volatile memory devices 121210, floppy and other removable disks, hard disk drives, optical disks (e.g., Compact Disk Read-Only Memory (CD ROMS), Digital Versatile Disks (DVDs)), and transmission-type media such as digital and analog communication links.

The network adapter 1212 enables the processing system 1200 to mediate data in a network 1214 with an entity that is external to the processing system 1200 through any communication protocol supported by the processing system 1200 and the external entity. The network adapter 1212 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1212 can include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of, for example, one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method comprising:
receiving input indicative of a request to initiate a computer program residing on an electronic device;
launching the computer program in response to receiving the input;
capturing an image of a real-world environment that includes a foodstuff and a reference object;
parsing the image to identify the foodstuff and the reference object;
generating an augmented reality feature that is at least partially hidden beneath the foodstuff,
wherein the augmented reality feature is positioned within the real-world environment based on a known characteristic of the reference object.

2. The computer-implemented method of claim 1, wherein the reference object includes a patterned surface.

3. The computer-implemented method of claim 2, further comprising:
defining a three-dimensional (3D) reference space based the patterned surface; and
establishing a spatial relationship between the augmented reality feature, the foodstuff, and the reference object within the 3D reference space.

4. The computer-implemented method of claim 1, wherein the augmented reality feature is a digital creature or a digital item.

5. The computer-implemented method of claim 1, further comprising:
animating at least a portion of the augmented reality feature,
wherein the at least a portion of the augmented reality feature is animated based on the known characteristic of the reference object.

6. The computer-implemented method of claim 5, wherein the at least a portion of the augmented reality feature is exposed from the foodstuff.

7. A non-transitory computer-readable medium with instructions stored thereon that, when executed by a processor, cause the processor to perform operations comprising:
acquiring an image of a real-world environment captured by an image sensor of an electronic device;
parsing the image to identify a reference object having a known characteristic;
defining a three-dimensional (3D) reference space with respect to the reference object; and
generating an augmented reality feature whose features, position, or any combination thereof are determined based on the reference object.

8. The non-transitory computer-readable medium of claim 7, wherein the reference object includes at least one surface having a pattern printed thereon.

9. The non-transitory computer-readable medium of claim 8, wherein the pattern includes geometric shapes, alphanumeric characters, symbols, images, or any combination thereof.

10. The non-transitory computer-readable medium of claim 8, wherein the pattern includes element of at least two different colors.

11. The non-transitory computer-readable medium of claim 8, wherein the pattern is designed to be visually indistinguishable from other markings along an outer surface of the reference object.

12. The non-transitory computer-readable medium of claim 7, wherein the reference object is a tableware object designed to retain a foodstuff.

13. The non-transitory computer-readable medium of claim 12, wherein the augmented reality feature is at least partially embedded within the foodstuff.

14. The non-transitory computer-readable medium of claim 8, further comprising:
establishing, based on an orientation of the pattern, a location of the reference object within the 3D reference space;
modeling the reference object based on the known characteristic; and
cropping at least a portion of the augmented reality feature to account for a structural feature of the reference object.

15. The non-transitory computer-readable medium of claim 8, further comprising:
establishing, based on an orientation of the pattern, a location of the reference object within the 3D reference space;
modeling the reference object based on the known characteristic; and
animating at least a portion of the augmented reality feature to account for a structural feature of the reference object.

16. The non-transitory computer-readable medium of claim 7, wherein the reference object is detachably connectable to a physical object in the real-world environment.

17. An electronic device comprising:
a memory that includes instructions for populating a real-world environment with augmented reality features in an authentic manner,
wherein the instructions, when executed by a processor, cause the processor to:
cause an image of a real-world environment that includes a reference object having a known characteristic to be captured;
parse the image to identify an orientation of the reference object in the real-world environment;
generate an augmented reality feature related to the reference object; and
cause the augmented reality feature to perform an animation involving the reference object.

18. The electronic device of claim 17, wherein the processor is configured to continually execute the instructions such that a determination is made as to whether a modification of the augmented reality feature is necessary for each image in a series of images representing a live video feed.

19. The electronic device of claim 17, wherein the instructions further cause the processor to;
generate a signal indicative of the animation; and
transmit the signal to the reference object,
wherein receipt of the signal prompts the reference object to generate a sensory output.

20. The electronic device of claim 19, wherein the sensory output is visual, auditory, haptic, somatosensory, or olfactory in nature.
